(19) United States
(12) Patent Application Publication
(10) Pub. No.: US 2026/0314644 A1
(43) Pub. Date: Oct. 15, 2026

(54) PACKAGED OIL-IN-WATER EMULSIFIED FOOD COMPOSITION

(71) Applicant: CONOPCO, INC., D/B/A UNILEVER, Hoboken, NJ (US)

(72) Inventors: Cornelis Laurentius SASSEN, Gorinchem (NL); Maarten Hendrik Johan LIESHOUT, Heiloo (NL)

(73) Assignee: Conopco, inc., d/b/a UNILEVER, Hoboken, NJ (US)

(21) Appl. No.: 19/104,504

(22) PCT Filed: Jul. 12, 2023
(86) PCT No.: PCT/EP2023/069378

§ 371 Date: Feb. 18, 2025

(30) Foreign Application Priority Data
Sep. 1, 2022 (EP) 22193494.6

(51) Int. Cl. A23L 27/60; A23L 27/00; A23L 29/10; A23L 33/115; B65D 1/32; B65D 47/06; B65D 85/72

(52) U.S. Cl. CPC A23L 27/60; A23L 27/82; A23L 29/10; A23L 33/115; B65D 1/32; B65D 47/06; B65D 85/72

(57) ABSTRACT

Use of polypropylene in a tottle type container containing an oil-in-water-emulsified food composition comprising octenyl succinic anhydride modified starch or plant protein, to facilitate discharge of the food composition from the tottle type container.

The present invention relates tot the use of polypropylene in a container of the tottle type, comprising an oil-in-water emulsified food composition.

### BACKGROUND

Oil-in-water-emulsified food compositions such as mayonnaise, savoury sauces or salad dressings can be conveniently packaged in a tottle-type of bottle. A “tottle”, a word commonly known in the packaged food industry, is a bottle type, often used for ketchup, mayonnaise or sauces, etc, can be positioned on the cap (so-called “top down” or “upside down” bottle). While a “bottle” sits on its “bottom” and has a cap at the top, a “tottle” sits on its “top,” which is also the cap. The consumer may describe this type of bottle as an “upside-down bottle”.

Tottles containing an oil-in-water emulsified food composition such as mayonnaise or a mayonnaise-like sauce, are known. A problem that is observed in the industry and by the consumer is that the food composition sticks to the inner wall of the tottle. To collect the sauce stuck to the inner wall, the consumer may swing the tottle or hammer it on the table, in an attempt to sweep the stuck material towards the spout. It is understandably frustrating that a significant part of the tottle content cannot be consumed, or only after frustrating effort.

Several attempts have been undertaken by the industry to reduce this problem. For example, it was recognized by the industry that coating of the inner wall of the tottle with vegetable oil facilitates discharge of mayonnaise from the tottle. As known in the industry, mayonnaise uses egg yolk as emulsifier to stably disperse the oil droplets within the continuous water phase of the emulsion. An oil-coated tottle containing mayonnaise wherein the emulsifier is yolk that has been modified with enzyme, thereby enhancing its emulsifying properties, faced severe complications regarding product discharge, when used in the oil-coated tottle. WO2016/102158 A1 describes a specific coating composition to overcome this problem related to emulsions wherein enzyme-modified egg yolk is used as emulsifier. The emulsified product is not in contact anymore with the bottle wall, but with the coating, thereby facilitating discharge. Efficient discharge of an emulsified product from a tottle is not a straight-forward exercise, and depends on the specific product ingredients and their interaction with the bottle surface.

It was recognized by many consumers and by the present inventors, that the problem of product discharge is even more significant if the tottle comprises a mayonnaise-like sauce that uses a vegan emulsifier such as plant protein or octenyl succinic anhydride (OSA)-modified starch. Coating of the inner wall of the tottle using vegetable oil or using oil comprising compounds as used in WO 2016/102158 A1 did not result in acceptable discharge improvement and/or in significant and unacceptable separation of oil from the emulsion.

U.S. Pat. No. 10,611,531 B discloses a liquid dispenser for dispensing liquid from an inverted container. The dispenser includes a body adapted for releasably engaging to the container, a valve localized in the body and defining a dispensing orifice that reacts to pressure differences for dispensing liquid to the exterior atmosphere, and an impact resistance system.

The challenge therefore remained in the industry how to facilitate product discharge from a tottle that contains an oil-in-water emulsified food composition wherein a plant protein or OSA-modified starch is used as emulsifier.

### SUMMARY OF THE INVENTION

Surprisingly, the solution for this specific problem was found in the use of a tottle comprising polypropylene (PP). Typically, tottles for application in packaging of mayonnaise-like dressings are prepared from polyethylene terephthalate (PET), polyethylene (PE) or polypropylene (PP), wherein PET is increasing in popularity. The inner wall may be coated, as described above. To the best knowledge of the inventors, the use of polypropylene in a tottle to overcome the problem of emulsion sticking to the inner wall of the tottle is not known.

The invention therefore relates to the use of polypropylene in a tottle type container containing an oil-in-water-emulsified food composition comprising:
vegetable oil,
water,
emulsifier comprising octenyl succinic anhydride modified starch or plant protein,

wherein the container comprises a body and a cap,

to facilitate discharge of the food composition from the container.

### DETAILED DESCRIPTION

In the present invention, it was surprisingly found that oil in water emulsified food compositions using a plant protein or OSA-modified starch emulsifier could be discharged from a tottle-type container efficiently when the tottle comprises PP.

All percentages, unless otherwise stated, refer to the percentage by weight (wt %). “Weight ratio” means that the concentration (wt %) of a first (class of) compound(s) is divided by the concentration (wt %) of a second (class of) compound(s) and multiplied by 100 in order to arrive at a percentage.

Except in the operating and comparative examples, or where otherwise explicitly indicated, all numbers in this description indicating amounts or ratios of material or conditions of reaction, physical properties of materials and/or use are to be understood as modified by the word “about”.

Features described in the context of one aspect of the invention (for example, the use) can be applied in any other aspect of the invention (for example, the method).

### Tottle

The present invention relates to the use of a tottle type container.

It is typically most functional that the area of the tottle type container that is in contact with the food composition is polypropylene. A tottle wherein the innerwall is not coated therefore is preferred. The oil-in-water emulsified food composition contained in the tottle is not considered a coating here, as the skilled person understands. Accordingly, the tottle is preferably not coated with oil, or with oil containing monoglycerides of a fatty acid, sucrose fatty acid esters, sorbitan fatty acid esters or lecithin. No coating step of the inner surface of the tottle preferably is present before filling of the tottle with the oil-in-water emulsified food composition.

As known in the art, the wall of a tottle may comprise several layers. In the present invention the wall of the tottle body consists of polypropylene or consists of several material layers, wherein the inner layer is polypropylene, as this is the layer that is in contact with the emulsified food composition. It is more preferred, that the wall of the body of the tottle comprises an oxygen barrier layer. This oxygen barrier layer is preferably an ethylenevinylalcohol layer. The body of the tottle comprises preferably an inner layer of polypropylene, facing the packaged food composition, an outer layer of polypropylene, and an ethylenevinylalcohol layer positioned between them. In case protection from oxygen is less desired, a tottle wherein the body consists of polypropylene may be preferred.

It may be preferred that the cap of the tottle comprises polypropylene, preferably consists of polypropylene.

The polypropylene used in the wall of the tottle or in the cap can be virgin polypropylene or it can be preferred that the polypropylene comprises recycled polypropylene, or even more preferred that the polypropylene is recycled polypropylene.

The tottle type container typically comprises a spout, positioned inside of the cap. It is preferred, that the spout is prepared from polypropylene and is translucent or transparent.

The volume of the tottle is preferably of from 100 to 2500 ml, preferably of from 200 to 1000, and preferred sies can for example be of from 200 to 500, preferably of from 200 to 300 ml, or from 400 to 600 ml or from 600 to 900 ml and. The volume represents the amount of emulsified food composition that is present in the tottle after complete filling. This is understood as filled under standard industry norms and conditions, as known in the art.

### Emulsion

The composition of the first aspect of the invention is in the form of an oil-in-water emulsion and the process of the second aspect of the invention results in an oil-in-water emulsified food composition. Examples of oil-in-water emulsions encompassed by the present invention include semi-solid emulsified sauces, such as mayonnaise, and mayonnaise-like emulsions, hummus, aioli. Other semi-solid oil-in-water emulsified food composition include food concentrates in emulsified form which upon dilution with water (or aqueous products e.g. fruit or vegetable juices, vinegar, wine, etc.) give soups, sauces, or liquid dressings that can be in emulsified form. Preferably, the food composition is a mayonnaise or a mayonnaise-like product, such as a low-oil mayonnaise or egg-less mayonnaise.

Mayonnaise is generally known as a thick, creamy sauce that can be used as a condiment with other foods. Mayonnaise is a stable water-continuous emulsion of typically vegetable oil, egg yolk and either vinegar or lemon juice. In many countries the term mayonnaise may only be used in case the emulsion conforms to the “standard of identity”, which defines the composition of a mayonnaise. For example, the standard of identity may define a minimum oil level, and a minimum egg yolk amount. However, in the present context, mayonnaise-like products having e.g. oil levels lower than defined in a standard of identity or not containing egg yolk are in the scope of the present invention. In the art, this kind of products may contain thickeners like starch to stabilise the aqueous phase. Mayonnaises and mayonnaise-like products may vary in colour, and are generally white, cream-coloured, or pale yellow. The texture may range from light creamy to thick. Generally, mayonnaise and mayonnaise-like products are semi-solid. Mayonnaises in the context of the present invention do not necessarily need to conform to a standard of identity in any country.

### Oil

The oil-in-water emulsified food composition according to the invention is preferably free from animal products and preferably a plant-based composition suitable for consumers that appreciate vegan products. Accordingly, the composition comprises vegetable oil. Vegetable oil is preferably present in an amount of from 5 to 82 wt %, preferably 10 to 80 wt %, preferably of from 15 to 78 wt %, even more preferably of from 65 to 78 wt %, based on the weight of the food composition. Animal derived fat, such as milkfat or butter is preferably absent from the composition.

Vegetable oil is known in the art, and includes oils derived from e.g. plants, such as from for example nuts or seeds from plants. In the context of this invention, ‘vegetable oil’ also includes oil from algae. Preferred oils for use in the context of this invention are vegetable oils which are liquid at 20° C., preferably, which are liquid at 5° C. Preferably the oil comprises an oil selected from the group consisting of sunflower oil, rapeseed oil, olive oil, soybean oil, and combinations of these oils. Most preferred, the oil is soybean oil or rapeseed oil or sunflower oil.

### Water

The composition of the invention comprises water. The total amount of water in the composition is preferably of from 15 to 96 wt %, preferably of from 18 to 90 wt %, based on the weight of the composition. “Total amount of water” includes water originating from water-containing ingredients.

### Emulsifier

The composition of the invention is an oil-in-water emulsion. It comprises an oil-in-water emulsifier. The emulsifier is preferably present in an amount of from 0.1 to 15 wt %, preferably 0.1 to 12 wt %, even more preferably of from 0.3 to 5 wt %, based on the weight of the oil-in-water emulsion. The emulsifier serves to stably disperse oil droplets in the continuous aqueous phase of an oil-in-water emulsion.

The composition of the invention comprises octenyl succinic anhydride modified starch or plant protein as the emulsifier.

OSA-modified starch is European food additive E1450. OSA-modified starch is preferably present in an amount of from 0.3 to 5 wt %, preferably of from 0.5 to 2 wt %. This emulsifier is available commercially as for example N-creamer 46, ex Ingredion Inc. (Westchester, IL, USA).

Preferably plant protein is present in the composition in an amount of from 0.3 to 5 wt %, based on the weight of the composition. Preferably, the amount of plant protein is of between 0.5 and 2.5 wt %, preferably of between 0.7 and 1.5 wt %, based on the weight of the composition. An amount for example may be preferred of more than 0.5 wt %. An amount may be preferred of less than 1.1 wt %, based on the weight of the composition.

The plant protein is preferably selected from the group consisting of pulse protein, oil seed protein, potato protein and mixtures thereof. Preferably the plant protein is pulse or potato protein. Pulse is the family of Fabaceae.

Pulse protein is preferably selected from the group consisting of pea protein, lentil protein, chickpea protein, lupin protein, faba bean protein, soy protein and mixtures thereof. It can however be preferred that the composition does not comprise soy protein. More preferably, pulse protein is selected from the group consisting of pea protein, chickpea protein, lentil protein, soy protein and mixtures thereof. Even more preferably pulse protein is selected from the group consisting of pea protein, chickpea protein and mixtures thereof. Most preferred, the pulse protein is pea protein (Pisum sativum). Pulse protein is preferably present in a total amount of from 0.01 to 2 wt %, more preferably in an amount of from 0.03 to 1.5 wt %, based on the weight of the oil in water emulsion.

Oil seed protein is preferably selected from the group consisting of rape seed protein, canola protein, sunflower protein, and mixtures thereof, preferably is rape seed protein.

Preferably, the plant protein is derived from one of the group consisting of soybeans, corn, pea, chickpea, canola, sunflower, sorghum, rice, faba, amaranth, potato, tapioca, arrowroot, canna, lupin, rape, wheat, oats, rye, barley, soy, potato, mung, algae, and mixtures thereof. More preferably, the emulsifier is plant protein and selected from the group consisting of potato protein, pea protein, chickpea protein, faba bean protein, sunflower protein, soy protein and mixtures thereof. Even more preferably, the protein is selected from the group consisting of soy or pea or faba bean or potato protein.

The composition preferably may comprise a source of such protein and the protein may be added in the form of source of protein, such as a protein isolate (e.g. the globulin fraction or albumin fraction or both), protein hydrolysate, protein concentrate, extract (like aquafaba), flour and combinations thereof.

More preferably, the emulsifier is selected from the group consisting of potato protein, algae protein, pulse proteins, OSA-modified starch and mixtures thereof. Proteinaceous emulsifier such as algae protein and pulse protein, are preferably present in a total amount of from 0.01 to 2 wt %, more preferably in an amount of from 0.03 to 1.5 wt %, based on the weight of the oil in water emulsion. Even more preferably, the emulsifier is selected from the group consisting of OSA-modified starch, pea protein, soybean protein, chickpea protein, lentil protein, fava bean, and mixtures thereof.

Most preferably, the emulsifier is OSA-modified starch. OSA-modified starch is preferably present in an amount of from 0.2 to 5 wt %, preferably from 0.5 to 2 wt %, based on the weight of the composition.

The composition of the invention is preferably free from egg-derived emulsifier, and preferably free from dairy protein. It is preferably free from egg yolk, enzyme-modified egg-yolk or egg-derived lecithin. It is preferably free from whey protein or casein. It is preferably free from monoglycerate. In this way a vegan oil-in-water emulsion can be created without ingredients from animal origin.

### Acid and PH

The composition of the invention preferably has a pH ranging from 2.5 to 7.5, preferably ranging from 3.5 to 6.5, preferably ranging from 3.5 to 4.5.

Preferably the composition of the invention has a total titratable acidity ranging from 0.03% to 3% by weight expressed as acetic acid, preferably from 0.05% to 2% by weight, preferably from 0.1% to 1% by weight.

Accordingly, the composition of the invention preferably comprises acidulant. Acidulant is preferably selected from the group consisting of acetic acid, citric acid, lactic acid, sorbic acid and mixtures thereof. The composition preferably comprises acetic acid. Acetic acid is preferably present in an amount of more than 50 wt %, more preferably more than 80 wt %, even more preferably more than 90 wt %, even more preferably more than 95 wt % based on the weight of the total amount of acid in the composition. The acetic acid may typically be added in the form of vinegar. Hence, the composition preferably comprises vinegar.

### Other Ingredients

It may be preferred, that the composition of the invention contains additionally other ingredients than already specifically mentioned in here. For example, it may be preferred, that the composition contains plant material in the form of herbs and/or spices. In case such ingredients are present in the composition, then generally their total concentration is at least 0.1% by weight, and preferably maximally 10% by weight, preferably maximally 5% by weight.

The composition of the invention may comprise sugar. High levels are not desired. Sugar may be present in an amount of from 0.1 to 15 wt %, preferably of from 0.3 to 12 wt %, even more preferably of from 0.4 to 10 wt %, most preferably of from 0.5 to 8 wt %, based on the weight of the composition.

Total alkaline metal salt, preferably sodium chloride, may be present in an amount of from 0.1 to 5 wt %, preferably from 0.15 to 4 wt %, or more preferably of from 0.2 to 3 wt %, based on the weight of the composition.

The composition may comprise mustard, e.g. as a flavour compound. Mustard may be present for example in an amount of from 0.5 to 10 wt %, more preferably 1 to 9 wt %, even more preferably 2 to 8 wt %, even more preferably of from 3 to 7 wt %.

It can be preferred, that hydrocolloid texturisers apart from OSA-modified starch are present, such as for example xanthan gum or guar gum, or dietary fibers (e.g. citrus fibre). However, it is more preferred, that the food composition does not contain hydrocolloid texturiser other than the OSA modified starch. Preferably the composting is free from xanthan gum or guar gum, more preferably it is free from both. It may be preferred, that the OSA-modified starch is the only hydrocolloid texturiser in the food composition. It could however be preferred that starch-based texturiser is present, preferably selected from the group consisting of native starch, chemically modified starch or physically modified starch.

Accordingly, the composition may comprise preferably native starch, chemically modified starch or physically modified starch, more preferably native starch or physically modified starch, in an amount of from 0.1 to 10 wt %, preferably of from 1 to 5 wt %, more preferably of from 2 to 4 wt %, based on the weight of the water phase. The water phase includes all water-soluble components in the composition and the water. Native starch is starch that is not modified chemically or physically. Native starch or physically modified starch is preferably selected from the group consisting of corn starch, potato starch, tapioca starch, rice starch, wheat starch, pea starch and mixtures thereof. Preferably the non-modified starch or chemically modified starch or physically modified starch, preferably native starch or physically modified starch, is corn starch, potato starch, wheat starch, or rice starch. Even more preferably the non-modified starch, chemically modified starch or physically modified starch, preferably native starch or physically modified starch, is waxy corn starch, waxy wheat starch, waxy potato starch, or waxy rice starch. Most preferably, the non-modified starch, chemically or physically modified starch, preferably native starch or physically modified starch, is waxy corn or waxy rice starch. Native starch may preferably be added in the form of starch or flour. The composition of the invention is a semi-solid. Such is known typically from traditional mayonnaise compositions with high oil level (e.g. 78% oil). The rheological properties of the composition can be expressed in Stevens Value (in grams) and/or as elastic property. The Stevens Value (in grams), especially for mayonnaise and mayonnaise-like compositions, is preferably from 80 g to 400 g, preferably of from 80 g to 200 g, even more preferably 100 g to 200 g, or even 100 g to 150 g, as measured at 20° C. This is preferably assessed some time, e.g. a week, or 2 weeks, after production, when products are stabilized and typically on the shelf. It is in particular in the area of higher consistency (80-400 grams Stevens), that the present invention shows it further advantage regarding syneresis reduction while maintaining a smooth, non-sticky mouthfeel, as in liquid compositions this problem is not present, as the skilled person understands. The composition of the invention therefore preferably has a Stevens consistency of between 80 g and 400 g, more preferably of between 100 g and 200 g, and even more preferably of between 100 g and 150 g, as measured at 20° C.

Use Tottle-type containers comprising PP and containing an oil-in-water emulsified food composition are known. It was surprisingly discovered by the present inventors, that an oil-in-water emulsified food composition which comprises an emulsifier comprising OSA-modified starch or plant protein could be satisfyingly discharged from the tottle when the tottle comprises polypropylene. It was discovered that the use of a PP-comprising tottle for the purpose of minimizing the residual amount of this specific emulsified food composition (i.e. using OSA starch or plant protein) after evacuation, and facilitating discharge of this specific product, was not realised yet in the art. The residues appeared to stick to the inside of the tottle to a much lesser extent than observed for the same composition in a PET tottle or in a PET tottle coated with oil or oil with lecithin, as are known in the art. To the best knowledge of the inventors, the use of a PP comprising tottle for the purpose to facilitate the discharge of this specific emulsified composition and to reduce the amount of residual composition sticking to the inner wall is not known.

In particular, it was observed, that the amount of residual composition after evacuating the tottle was less than 16 wt %, preferably less than 12 wt % of the initial product amount present in the tottle. This is measured by weighing the tottle at the start and at the end of the product evacuation test, and by deducing the empty packaging weight, the net product leftovers can be calculated and expressed as a weight percentage. Accordingly, the invention relates to the use according to the invention, wherein preferably the net product leftover residue of oil-in-water emulsified food composition after evacuating the tottle is less than 16 wt %, preferably less than 12 wt %, measured by weighing the full tottle and the tottle after evacuation of the tottle, and deducing the weight of the clean tottle, and expressing the left over as a weight percentage based on the weight of the oil-in-water emulsion in the full tottle.

In a further aspect, the present invention relates to a method of reducing the amount of left-over product in a tottle-type container, or facilitating discharge of product from a tottle type container, wherein the product is an oil-in-water-emulsified food composition comprising:
vegetable oil,
water,
emulsifier comprising octenyl succinic anhydride modified starch or plant protein, wherein the tottle comprises a body and a cap, wherein the tottle-type container comprises polypropylene.

The method preferably comprises the steps of:
(i) identifying an oil-in-water emulsified food composition packaged in a tottle type container, wherein the composition comprises:
vegetable oil,
water,
emulsifier comprising octenyl succinic anhydride modified starch or plant protein, and the tottle comprises a body and a cap; and
(ii) replacing at least part of the material from which the tottle is manufactured with polypropylene, thereby improving discharge of the composition from the container.

The method preferably comprises the step of having the tottle filled up with product. The method preferably comprises the step of evacuating the tottle by opening the cap and squeezing the tottle several times, to allow the tottle to evacuate. It is clear that in this context the evacuation process may require more than one squeeze, and that the squeezing continues till no product is discharged from the tottle by squeezing. The net product leftover residue of oil-in-water emulsified food composition after evacuating the tottle comprising polypropylene is preferably less than 16 wt %, preferably less than 12 wt %. Preferably the composition identified in step (i) above has a net product leftover residue of oil-in-water emulsified food composition after evacuating the tottle of more than 16 wt %, more preferably more than 17 wt %.

Preferably the method comprises a step of labelling and/or associating the product with indications that the product has (a) optimal and/or improved discharge; and/or (b) minimal and/or reduced leftover residue. The indications are preferably displayed on a label applied to the tottle.

The consistency of compositions used in or in relation to the present invention preferably is of from 50 to 140 grams, preferably of from 70 to 120 grams.

Consistency in the context of the present invention can be measured using Stevens value, which can be measured as follows:

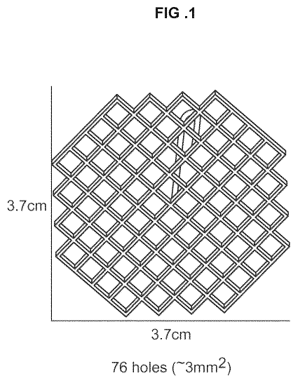

Thickness—Stevens value: the Stevens value is determined at 20° C. by using a Stevens LFRA Texture Analyser (ex Brookfield Viscometers Ltd., UK) with a maximum load/measuring range of 1000 grams, and applying a penetration test of 25 mm using a grid, at 2 mm per second penetration rate, in a cup having a diameter of 65 mm, that contains the emulsion; wherein the grid comprises square openings of approximately 3×3 mm, is made up of wire with a thickness of approximately 1 mm, and has a diameter of 40 mm. One end of a shaft is connected to the probe of the texture analyser, while the other end is connected to the middle of the grid. The grid is positioned on the flat upper surface of the emulsion in the cup. Upon starting the penetration test, the grid is slowly pushed downward into the emulsion by the texture analyser. The final force exerted on the probe is recorded, giving the Stevens value in gram. A drawing of the grid is given in FIG. 1. The grid is made from stainless steel, and has 76 holes, each hole having a surface area of approximately 3×3 mm.

The invention will now be exemplified with the following, non-limiting examples.

### EXAMPLES

### Example 1

### Ingredients

Rapeseed oil (fully refined, not hydrogenated), water, spirit vinegar (10% HAc), sugar, salt, OSA-modified starch (N-creamer, supplier Ingredion), lemon juice concentrate (45 Brix), flavouring, calcium disodium EDTA.

### Method

An oil in water emulsified food composition was prepared using the above ingredients in the following amounts:

| Ingredient | Amount [weight %] |
|---|---|
| Rapeseed oil | 72 |
| Water | 17.2 |
| Spirit vinegar | 5 |
| Sugar | 2.7 |
| Salt | 1.5 |
| OSA-modified starch | 1.2 |
| Lemon juice | 0.2 |
| concentrate | |
| Flavouring | 0.2 |
| Calcium disodium | 0.007 |
| EDTA | |
| total | 100% |

The above-mentioned oil in water emulsified food composition was prepared by using a standard Food High Shear Emulsifier (Fryma Koruma). The equipment includes a stirred vessel to which vacuum can be applied. The vessel is equipped with an integrated colloid mill to produce an oil-in-water emulsion with a typical semi-solid mayonnaise consistency as well known in the art.

### The Process Comprises the Following Steps:

Dose water, vinegar, sugar, salt, lemon juice concentrate, calcium disodium EDTA,
Stir until all dry materials are completely dissolved and the mix is fully homogeneous,
Add the OSA-modified starch and homogenize the mix,
Add the oil and flavouring, and pass the mix over the colloid mill until a typical mayonnaise consistency has been reached,
Pump the mix to a buffer tank which is connected to the tottle filling machine,
Fill and close the tottles. 407 g of mayonnaise is dosed in a PET tottle with a nominal filling volume of 430 ml. 433 g of mayonnaise is dosed in a PP tottle with a nominal filling volume of 450 ml.
In case of coated PET tottles, a coating film is applied just before filling, with a surface coverage of about 0.002 g/cm², which can be suitably done as described for example in EP3237506B1.

The texture of the resulting compositions was measured as 93 g (product in PP bottle) and 103 g (product in PET bottles).

### Method to Measure the Reduction in Leftovers:

After a minimum of two weeks maturation (at ambient, ca. 20° C.), the product is expelled from the tottles in two steps:
1) Repeatedly squeeze the tottle without permanently deforming the tottle. This is done by gently shaking by hand until no reasonable amount of product (~5 g) can be expelled and/or splattering occurs. The tottles are kept top down for 24 hrs (at 4 to 8° C.)
2) After 24 hrs, the cap is opened and the tottle is squeezed by hand without shaking until no more product can be expelled. Subsequently (to simulate consumer shaking), the tottle is banged (cap down) on the table from 10-centimeter height for 3 times and squeezed by hand until no more product can be expelled. This is repeated to a total of 5 times.

By weighing the tottle at the start and at the end of the product evacuation test, and by deducing the empty packaging weight, the net product leftovers can be calculated and expressed as a weight percentage.

Results

| | Packaging | Leftovers (wt. %) | Phase separation |
|---|---|---|---|
| Ex 1 | PP | 9.6% | no |
| Comp 1 | PET | 18.9% | no |
| Comp 2 | PET, coated with | 3 to 4% | Yes, excessive oil |
| | vegetable oil film | | separation, not |
| | comprising lecithin | | acceptable |

### Conclusion Example 1

When the OSA-modified starch-emulsified composition is discharged from a PET tottle (comparative example 1), significant residue is maintained (18.9%). Applying an oil coating comprising lecithin, as suggested in the art, resulted in destruction of the composition (comparative example 2). The use of a PP tottle resulted in a significant reduction of left-over, almost 50%, illustrating the superiority of using a PP tottle for the purpose of facilitating discharge and of reducing residue after discharge.

### Example 2

In example 2 it has been assessed if coating the PET tottle with oil would result in a solution for the left-over problem.

### Ingredients

Rapeseed oil (fully refined, not hydrogenated), water, spirit vinegar (12% HAc), modified potato starch (amylose-free, supplier Royal Avebe U.A.), sugar, salt, OSA-modified starch (N-creamer, Ingredion), lemon juice concentrate (40 Brix), flavouring, sorbic acid, calcium disodium EDTA.

### Method

An oil in water emulsified food composition was prepared using the above ingredients in the following amounts:

| Ingredient | Amount [weight %] |
|---|---|
| Rapeseed oil | 53 |
| Water | 37.9 |
| Spirit vinegar | 2.4 |
| Potato starch | 1.9 |
| Sugar | 1.85 |
| Salt | 1.7 |
| OSA-modified starch | 0.75 |
| Lemon juice | 0.2 |
| concentrate | |
| Flavouring | 0.2 |
| Sorbic acid | 0.1 |
| Calcium disodium | 0.007 |
| EDTA | |
| Total | 100% |

The above-mentioned oil in water emulsified food composition was prepared by a process comprises the following steps:
Oil phase preparation by dissolving the flavouring in the oil using a stirred tank
Aqueous phase 1 preparation by dissolving sugar, salt, OSA-modified starch and Calcium disodium EDTA in part of the water [17% of 37.9%] using a stirred tank
Aqueous phase 2 preparation by adding lemon juice concentrate, spirit vinegar, sorbic acid and potato starch to the remaining part of the water [20.9% of 37.9%] using a stirred tank
Aqueous phase 2 pasteurization for 5 minutes at 72° C. and subsequent cooled to 25° C.
Mixing the oil phase and aqueous phase 1 in a stirred vessel providing sufficient shear to prepare an oil-in-water emulsion
Passing this oil-in-water emulsion through a colloid mill applying 10.000 rpm
Post-dosing aqueous phase 2 with the oil-in-water emulsion by using a dynamic mixer
Passing the resulting oil-in-water emulsion through a colloid mill applying 2.000 rpm
Fill and close the tottles. 400 g of mayonnaise is dosed in a tottle with a nominal filling volume of 430 ml.
In case of coated tottles, a coating film is applied just before filling (about 0.002 g/cm² on inner surface), which can be suitably done as described for example in EP3237506B1.

The final product is characterized by a Stevens value of 78, measured at 24 hours after production.

The same method as described in Example 1 was applied to determine the amount of product left-over.

Results

| | Packaging | Leftovers (wt. %) | Phase separation |
|---|---|---|---|
| Comp 3 | PET | 20% | No |
| Comp 4 | PET, coated with | 17% | No |
| | vegetable oil film | | |

### Conclusion Example 2

The assessment shows that coating a PET tottle with vegetable oil (Comparative example 4) does not provide a major improvement in terms of reducing residue after discharge, compared to a non-coated PET tottle (comparative example 3), 17% vs. 20%, respectively. This indicates that coating a PET bottle with vegetable oil, a solution known in the art, is not solving the problem of significantly reducing left-over after discharge in case the product is an OSA-modified starch-emulsified food composition.

### CONCLUSION

When a polypropylene tottle is used to package an OSA-modified starch-emulsified oil-in-water emulsion, the amount of product left over after evacuation of the tottle is minimal compared to discharge-facilitating solutions used in the art. Coating using oil that comprises lecithin results in severe phase separation of the product. This illustrates, that the use of polypropylene comprising tottles to facilitate discharge and to reduce sticking of left over to the inner tottle wall after evacuation of the tottle is superior to other known solutions.

1.-14. (canceled)

15. A method for facilitating the discharge of an oil-in-water-emulsified food composition from a tottle type container, the method comprising the steps of:
(i) identifying the oil-in-water emulsified food composition packaged in the tottle type container, wherein the oil-in-water emulsified food composition comprises:
vegetable oil,
water, and
an emulsifier comprising octenyl succinic anhydride modified starch or plant protein, and
wherein the tottle type container comprises a body and a cap; and
(ii) replacing at least part of the material from which the tottle type container is manufactured with polypropylene, thereby improving discharge of the composition from the container.

16. A method to improve discharge of an oil-in-water-emulsified food composition from a container comprising:
(i) selecting a tottle-type container; and
(ii) adding the oil-in-water-emulsified food composition to the tottle-type container, and
(iii) evacuating the oil-in-water-emulsified food composition from the tottle-type container,
wherein the tottle-type container comprises a body and a cap,
wherein the body of the tottle-type container has at least three layers selected from an innerwall, an oxygen barrier layer, and an outer layer, and
wherein the innerwall is in contact with the oil-in-water-emulsified food composition and consists of polypropylene.

17. The method of claim 16, wherein the oxygen barrier layer is positioned in between the innerwall and the outer layer.

18. The method of claim 16, wherein the oxygen barrier layer is an ethylenevinylalcohol layer.

19. The method of claim 16, wherein the innerwall is free of a coating, wherein the coating is selected from oil, monoglycerides of fatty acids, sucrose fatty acid esters, sorbitan fatty acid esters, lecithin, or any combination thereof.

20. The method of claim 16, wherein the outer layer consists of polypropylene.

21. The method of claim 16, wherein the cap further comprises a spout, and wherein the spout is prepared from polypropylene and is translucent or transparent.

22. The method of claim 16, wherein the oil-in-water-emulsified food composition comprises from vegetable oil, water and an emulsifier comprising octenyl succinic anhydride modified starch or plant protein.

23. The method of claim 22, wherein the oil-in-water-emulsified food composition comprises from 65 to 78 wt % of the vegetable oil selected from soybean oil, rapeseed oil, sunflower oil, or any combination thereof.

24. The method of claim 16, wherein the oil-in-water-emulsified food composition is free from egg yolk, lecithin, whey protein, casein, monoglycerate, or any mixtures thereof.

25. The method of claim 16, wherein a net product leftover residue of the oil-in-water emulsified food composition after step (iii) is less than 16 wt %, measured by weighing the tottle-type container both prior to step (iii) and after step (iii), and deducing a weight the tottle-type container prior to step (ii).

26. The method of claim 25, wherein the net product leftover residue is less than 12 wt %, measured by weighing the tottle-type container both prior to step (iii) and after step (iii), and deducing the weight of tottle-type container prior to step (ii).

27. A method to reduce sticking of an oil-in-water-emulsified food composition to a container comprising:
(i) selecting a tottle-type container; and
(ii) adding the oil-in-water-emulsified food composition to the tottle-type container, wherein the oil-in-water-emulsified food composition comprises an emulsifier comprising octenyl succinic anhydride modified starch or plant protein, and
(iii) evacuating the oil-in-water-emulsified food composition from the tottle-type container,
wherein the tottle-type container comprises a body and a cap,
wherein the body of the tottle-type container has at least three layers selected from an innerwall, an oxygen barrier layer, and an outer layer,
wherein the innerwall is in contact with the oil-in-water-emulsified food composition, consists of polypropylene, and is free of a coating, wherein the coating is selected from oil, monoglycerides of fatty acids, sucrose fatty acid esters, sorbitan fatty acid esters, lecithin, or any combination thereof, and
wherein a net product leftover residue of the oil-in-water emulsified food composition after step (iii) is less than 16 wt %, measured by weighing the tottle-type container both prior to step (iii) and after step (iii), and deducing a weight the tottle-type container prior to step (ii).

28. The method of claim 27, wherein the oil-in-water-emulsified food composition further comprises from 65 to 78 wt % of the vegetable oil.

29. The method of claim 27, wherein step (iii) comprises squeezing the tottle-type container at least once.

30. The method of claim 27, wherein the oil-in-water-emulsified food composition has a Stevens Value from 80 to 400 g, measured at 20° C.

31. The method of claim 30, wherein the oil-in-water-emulsified food composition has a Stevens Value from 100 to 150 g, measured at 20° C.

32. The method of claim 27, wherein the oil-in-water-emulsified food composition has a pH from 3.5 to 4.5.

33. The method of claim 27, wherein the oil-in-water-emulsified food composition further comprises an acidulant selected from acetic acid, citric acid, sorbic acid, or any mixture thereof.

34. The method of claim 27, wherein the oil-in-water-emulsified food composition is free from egg yolk, lecithin, whey protein, casein, monoglycerate, or any mixtures thereof.
